(19) United States
(12) Patent Application Publication
(10) Pub. No.: US 2026/0303685 A1
(43) Pub. Date: Oct. 1, 2026

(54) CONNECTION ESTABLISHMENT

(71) Applicants: Douyin Vision Co., Ltd., Beijing (CN); Bytedance Technology Ltd., Grand Cayman (KY)

(72) Inventors: Zelong Yue, Beijing (CN); Jian Yang, Beijing (CN); Yong Zhang, Beijing (CN); Jianxi Ye, Los Angeles, CA (US); Hongyu Wu, Los Angeles, CA (US); Jian Wang, Beijing (CN)

(21) Appl. No.: 19/574,221

(22) Filed: Mar. 20, 2026

(30) Foreign Application Priority Data
Mar. 31, 2025 (CN) 202510397819.4

(51) Int. Cl. H04L 67/1097; H04L 67/141

(52) U.S. Cl. CPC H04L 67/1097; H04L 67/141

(57) ABSTRACT

Embodiments of the disclosure provide a method, an apparatus, a device, and a medium for connection establishment. In the method, a connection establishment request is received at a first device from a second device. The request includes first data for establishing a remote direct memory access (RDMA) connection. Then, based on thread configuration information for the first device, a thread in the first device associated with the first data is determined. The thread configuration information indicates an association between a thread and data. The thread associated with the first data is configured for determining whether the RDMA connection is to be established. If it is determined that the RDMA connection is to be established, a connection establishment response is sent from the first device to the second device. The connection establishment response includes second data for establishing the RDMA connection. The second data is associated with the first data.

### CROSS-REFERENCE

The present application claims priority to Chinese Patent Application No. 202510397819.4, filed on Mar. 31, 2025, and entitled “METHOD, APPARATUS, DEVICE, AND MEDIUM FOR CONNECTION ESTABLISHMENT”, the entirety of which is incorporated herein by reference.

### TECHNICAL FIELD

Example embodiments of the present disclosure generally relate to the field of computers, and in particular, to connection establishment.

### BACKGROUND

Remote direct memory access (RDMA) technology may reconstruct a network data transmission mode through mechanisms such as hardware offloading and kernel bypass, and provide communication capability of ultra-low latency, high throughput, and low CPU consumption for scenarios such as high-performance computing, AI training, and distributed storage.

As RDMA technology becomes increasingly mature and is deployed on a large scale in data centers (DCs), it has become the preferred technical solution in the industry for various high-performance service scenarios (for example, storage, recommendation search, and large model training/inference). The service scenarios supported by RDMA are becoming increasingly numerous and complex, which also brings more challenges and iterative evolution to various technical aspects of RDMA. In RDMA technology, “connection establishment” (also referred to as connection setup) may be used to complete the initial information exchange.

### SUMMARY

In a first aspect of the present disclosure, a method for connection establishment is provided. The method comprises: receiving, at a first device, a connection establishment request from a second device, where the connection establishment request comprises first data for establishing a remote direct memory access connection; determining a thread in the first device associated with the first data based on thread configuration information for the first device, where the thread configuration information indicates an association between a thread and data, and the thread associated with the first data is configured for determining whether the remote direct memory access connection is to be established; and in accordance with determination that the remote direct memory access connection is to be established, sending a connection establishment response from the first device to the second device, where the connection establishment response comprises second data for establishing the remote direct memory access connection, and the second data is associated with the first data.

In a second aspect of the present disclosure, a method for connection establishment is provided. The method comprises: determining, at a second device, first data for establishing a remote direct memory access connection; determining a thread in the second device associated with the first data based on thread configuration information for the second device, where the thread configuration information indicates an association between a thread and data; and sending a connection establishment request from the second device to a first device through the thread associated with the first data, where the connection establishment request comprises the first data.

In a third aspect of the present disclosure, an apparatus for connection establishment is provided. The apparatus comprises: a request reception module configured to receive a connection establishment request at a first device from a second device, where the connection establishment request comprises first data for establishing a remote direct memory access connection; a thread determination module configured to determine a thread in the first device associated with the first data based on thread configuration information for the first device, where the thread configuration information indicates an association between a thread and data, and the thread associated with the first data is configured for determining whether the remote direct memory access connection is to be established; and a response sending module configured to, in accordance with determination that the remote direct memory access connection is to be established, send a connection establishment response from the first device to the second device, where the connection establishment response comprises second data for establishing the remote direct memory access connection, and the second data is associated with the first data.

In a fourth aspect of the present disclosure, an apparatus for connection establishment is provided. The apparatus comprises: a data determination module configured to determine, at a second device, first data for establishing a remote direct memory access connection; a thread determination module configured to determine a thread in the second device associated with the first data based on thread configuration information for the second device, where the thread configuration information indicates an association between a thread and data; and a request sending module configured to send a connection establishment request from the second device to a first device through the thread associated with the first data, where the connection establishment request comprises the first data.

In a fifth aspect of the present disclosure, an electronic device is provided. The electronic device comprises at least one processor; and at least one memory coupled to the at least one processor and storing instructions executable by the at least one processor, the instructions, when executed by the at least one processor, causing the device to perform the method of the first aspect or the second aspect of the present disclosure.

In a sixth aspect of the present disclosure, a computer-readable storage medium is provided. The computer-readable storage medium has a computer program stored thereon, the computer program being executable by a processor to implement the method of the first aspect or the second aspect of the present disclosure.

It should be understood that the contents described in this section are not intended to identify key features or essential features of the embodiments of the present disclosure, nor are they intended to limit the scope of the present disclosure. Other features of the present disclosure will become readily apparent from the following description.

### BRIEF DESCRIPTION OF THE DRAWINGS

In conjunction with the drawings and with reference to the following detailed description, the above and other features, advantages, and aspects of the embodiments of the present disclosure will become more apparent. In the drawings, the same or similar reference numerals denote the same or similar elements, in which:

FIG. 1 illustrates a schematic diagram of an example environment in which embodiments of the present disclosure may be implemented;

FIG. 2 illustrates a schematic diagram of a kernel space RDMA communication manager;

FIG. 3A illustrates a schematic diagram of a user space RDMA communication manager according to some embodiments of the present disclosure;

FIG. 3B illustrates a schematic diagram of a signaling flow for connection establishment according to some embodiments of the present disclosure;

FIG. 4 illustrates a schematic diagram of a process of connection establishment according to some embodiments of the present disclosure;

FIG. 5 illustrates a schematic diagram of a process of disconnection according to some embodiments of the present disclosure;

FIG. 6 illustrates a flowchart of a method for connection establishment according to some embodiments of the present disclosure;

FIG. 7 illustrates a flowchart of a method for connection establishment according to some embodiments of the present disclosure;

FIG. 8 illustrates a schematic structural block diagram of an apparatus for connection establishment according to some embodiments of the present disclosure;

FIG. 9 illustrates a schematic structural block diagram of an apparatus for connection establishment according to some embodiments of the present disclosure; and

FIG. 10 illustrates a block diagram of a device capable of implementing multiple embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms, and should not be construed as limited to the embodiments set forth herein. Instead, these embodiments are provided for more thorough and complete understanding of the present disclosure. It should be understood that the drawings and the embodiments of the present disclosure are only for illustrative purposes, and are not intended to limit the protection scope of the present disclosure.

It should be noted that the titles of any sections/subsections provided herein are not restrictive. Various embodiments are described throughout this specification, and any type of embodiments may be included under any section/subsection. In addition, the embodiments described in any section/subsection may be combined with any other embodiments described in the same section/subsection and/or different sections/subsections in any manner.

In the description of the embodiments of the present disclosure, the term "include/comprise" and similar terms thereof should be understood as open-ended inclusions, that is, "include/comprise but not limited to". The term "based on" should be understood as "at least partially based on". The term "an embodiment" or "the embodiment" should be understood as "at least one embodiment". The term "some embodiments" should be understood as "at least some embodiments". Other explicit and implicit definitions may be included below. The terms "first", "second", and the like may refer to different or same objects. Other explicit and implicit definitions may be included below.

The embodiments of the present disclosure may involve user data, data acquisition, and/or data usage. These aspects comply with applicable laws, regulations, and relevant provisions. In the embodiments of the present disclosure, all data collection, acquisition, processing, handling, forwarding, and usage are performed on the premise that the user is informed and has provided confirmation. Accordingly, when implementing the embodiments of the present disclosure, appropriate means shall be employed in accordance with applicable laws and regulations to inform the user of, and obtain the user’s authorization for, the types of data or information that may be involved, the scope of use, and the usage scenarios. The specific manner of notification and/or authorization may vary depending on actual circumstances and application scenarios, and the scope of the present disclosure is not limited in this regard.

In the solutions of the embodiments of the present disclosure, if personal information processing is involved, such processing will be carried out only on the basis of a legitimate ground (for example, obtaining the consent of the personal information subject, or as necessary for the performance of a contract), and will be conducted only within the prescribed or agreed scope. A user’s refusal to allow the processing of personal information other than the necessary information required for basic functions will not affect the user’s use of the basic functions.

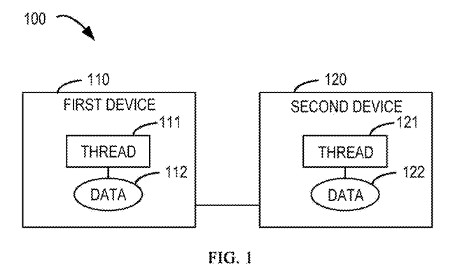

For ease of description, the following discussion takes the network environment 100 in FIG. 1 as an example. Specifically, FIG. 1 illustrates a schematic diagram of an example network environment 100. The example network environment 100 may comprise a first device 110 and a second device 120. The first device 110 or the second device 120 may comprise a server, a switch, or other devices that may perform data transmission, data storage devices, control devices, and/or other suitable devices.

The first device 110 may comprise one or more processes, and each process may comprise one or more threads, such as a thread 111. For example, the thread 111 may process data 112, and therefore the thread 111 may be considered to be associated with the data 112. Similarly, the second device 120 may also comprise one or more processes, and each process may comprise one or more threads, such as a thread 121. For example, the thread 121 may process data 122, and therefore the thread 121 may be considered to be associated with the data 122.

The first device 110 may communicate with the second device 120. For example, the first device 110 may send the data 112 to the second device 120 through the thread 111, and the second device 120 may receive the data 112 through the thread 121. The second device 120 may send the data 122 to the first device 110 through the thread 121, and the first device 110 may receive the data 122 sent by the second device 120 through the thread 111.

In some embodiments, the first device 110 and the second device 120 may be in a server-client structure. For example, the first device 110 is a server and the second device 120 is a client. Alternatively, the first device 110 is a client and the second device 120 is a server.

It should be understood that the example network environment 100 described in the present disclosure is merely for the purpose of description, and is not intended to impose any limitation on the embodiments of the present disclosure. The environment in the embodiments of the present disclosure may comprise any suitable number of devices and/or have any suitable topology, and the embodiments of the present disclosure are not limited in this regard. Additionally, any suitable number of processes and/or threads may be comprised in the first device 110 or the second device 120.

In the example network environment 100 as illustrated in FIG. 1, the first device 110 may establish an RDMA connection based on the data 122 of the second device 120, and the second device 120 may establish an RDMA connection based on the data 112 in the first device 110.

The RDMA transmission process is mainly divided into a control path and a data path. The control path comprises the process of establishing an RDMA connection. The data path comprises the data transmission process after the RDMA connection is established.

In RDMA transmission, “connection establishment” (also referred to as connection setup) may be used to complete the initial information exchange (RC, UC, RD, and UD all require it). During the connection establishment process, the two devices may learn each other’s information through negotiation and preparation, thereby being able to send and receive information mutually. The connection establishment process is different from a connection-oriented process. The connection establishment process has two approaches. One approach is based on a socket application programming interface (API), for example, in which transmission details are implemented by a user, and connection establishment information is transmitted using messages of the Transmission Control Protocol (TCP)/Internet Protocol (IP).

Another approach is based on a communication manager (CM) API for connection establishment, for example, using interfaces provided by the librdmacm library and transmitting connection establishment information using messages of the RDMA over Converged Ethernet (RoCE) and InfiniBand (IB) protocols. The librdmacm library is a user space library for connection management and communication abstraction in RDMA technology, which encapsulates the complexity of lower-layer interfaces through higher-level APIs and provides cross-protocol communication management capabilities. RoCE and IB are two high-performance network protocols based on RDMA, designed for low-latency and high-throughput data transmission scenarios.

Compared with the socket API, the CM API has complete and unified programming interfaces, without requiring a user to be concerned with the delivery of connection information. In addition, for the connection establishment approach based on the CM API, connection information is exchanged using the same path as the data traffic, and path failures may be perceived at the connection establishment stage. In the socket API-based method, the connection establishment path is different from the data path, and a situation may occur in which the connection establishment succeeds but the data transmission fails.

In addition, RDMA CM requires hardware support for the unreliable datagram queue pair (UD QP) function. In some hardware, the UD QP function may not be supported.

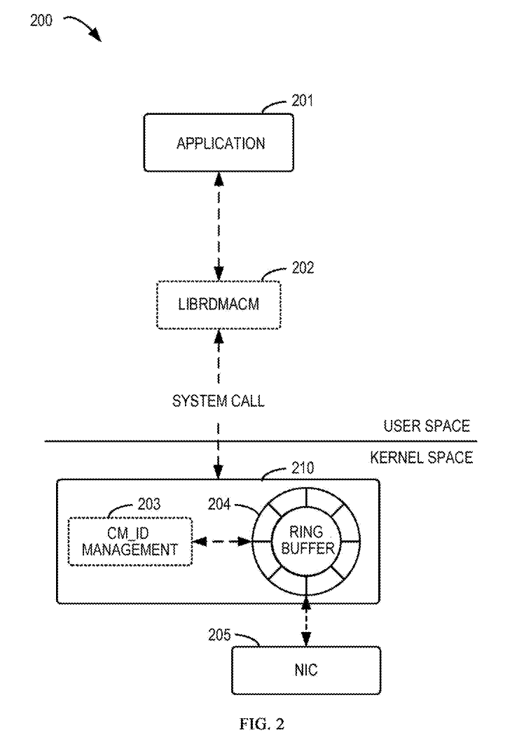

For ease of description, the following discussion takes the kernel space CM in FIG. 2 as an example. Specifically, FIG. 2 illustrates a schematic diagram of a kernel space CM 200. The kernel space CM 200 may comprise an application 201 and a librdmacm library 202 in user space, where the application 201 may be associated with the librdmacm library 202. Additionally, the kernel space CM 200 may further comprise a kernel 210 and a network interface card (NIC) 205. The kernel 210 may comprise CM_ID management 203 and a ring buffer 204.

In the kernel space CM 200, the application 201 may deliver an API call to the kernel 210 through a system call based on the librdmacm library 202, which may require multiple memory copies. For example, the kernel 210 may perform multiple memory copies through interfaces such as copy_to_user and copy_from_user to ensure correctness of the parameters received from the user and the values returned to the user, but the efficiency is low. In addition, when processing resources of the kernel space CM 200, the kernel 210 may need to frequently acquire locks to ensure that reading and writing of the resources do not conflict. If the scope of a lock is too large, performance issues may occur.

In the process of establishing or disconnecting an RDMA connection, the kernel space CM 200 may execute API calls. Since it cannot be ensured that the associated resources are not accessed by other threads, the kernel space CM 200 may need to lock the associated contexts.

When receiving a packet for establishing or disconnecting an RDMA connection, an application distribution thread may process the packet. For example, the application distribution thread may generate a task for each packet and place the task into a work queue. Any thread of the kernel space CM 200 may process the task, so locking is needed to prevent the task being processed from being accessed by other threads.

When establishing or disconnecting an RDMA connection based on the kernel space CM 200, the system call context overhead, multiple memory copies, multiple task distributions by the application distribution thread, and the locking process will lead to increased resource consumption in the connection establishment process and reduced efficiency.

Therefore, the performance of the RDMA control path process needs to be improved. For example, the conventional RDMA CM connection establishment method has insufficient performance in high-concurrency multi-connection scenarios, which needs to be solved. In addition, the CM may need to support hardware RDMA protocols, and also needs to rapidly customize and adjust message formats according to requirements while ensuring that upper-layer connection establishment interfaces remain unchanged. Further, the kernel space CM 200 can only provide error codes of API calls and partial connection states. If a fault occurs in the connection establishment process, troubleshooting the fault based on the kernel space CM 200 may require a large amount of time.

To at least partially address the above problems and other potential problems, embodiments of the present disclosure propose a solution for connection establishment. In the solution, a first device receives a connection establishment request from a second device. The connection establishment request comprises first data for establishing an RDMA connection. The first device determines a thread in the first device associated with the first data based on thread configuration information for the first device. The thread configuration information indicates an association between a thread and data. The thread associated with the first data is configured for determining whether the remote direct memory access connection is to be established. If it is determined that the remote direct memory access connection is to be established, the first device sends a connection establishment response to the second device. The connection establishment response comprises second data for establishing the remote direct memory access connection. The second data is associated with the first data. In this way, an RDMA connection can be established flexibly and efficiently between the first device and the second device.

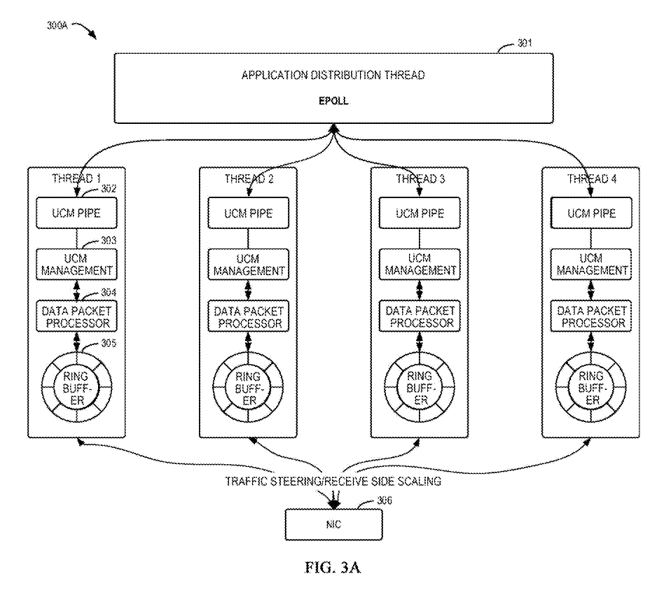

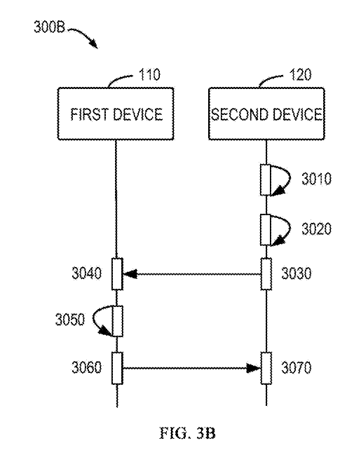

The following describes a solution for connection establishment according to some embodiments of the present disclosure with reference to FIGS. 3A-10. For ease of description, the following discussion takes the network environment 100 of FIG. 1 as an example. In the network environment 100, the first device 110 may comprise or be implemented as a switch, a router, a virtual machine, a computing node, a storage node, and/or similar devices, and either of the first device 110 and the second device 120 may perform the method for connection establishment according to the embodiments of the present disclosure.

FIG. 3A illustrates a schematic diagram of a user space CM (UCM) 300A according to some embodiments of the present disclosure. As shown in FIG. 3A, the UCM 300A may comprise thread 1, thread 2, thread 3, thread 4, and an NIC 306. The UCM 300A may communicate with an application distribution thread 301. The application distribution thread 301 may support a multiplexing mechanism EPOLL. EPOLL is used to manage read and write events of a large number of file descriptors (such as network sockets), and is particularly suitable for high-concurrency scenarios. The application distribution thread 301 may be used to monitor events through EPOLL. For example, after the UCM 300A receives a connection establishment request, the application distribution thread 301 may allocate work to a corresponding UCM thread based on the event type and related information, and execute a function call without using memory copying and context switching.

The NIC 306 in the UCM 300A is used for traffic steering or receive side scaling (for example, receive side scaling hash) of data processed by thread 1, thread 2, thread 3, and thread 4. In addition, the UCM 300A may be comprised in or implemented in the first device 110 and/or the second device 120 in FIG. 1.

A thread (for example, thread 1) in the UCM 300A may comprise a UCM pipe 302, UCM management 303, a data packet processor 304, and a ring buffer 305. The UCM 300A may implement a user space RDMA protocol stack based on a Data Plane Development Kit (DPDK). The UCM 300A may be used for managing connection states and sending or receiving connection establishment messages or disconnection messages. In the UCM 300A, a UCM thread (for example, thread 1) may construct a connection establishment message based on an application request and protocol type, and place the message into a ring buffer (for example, the ring buffer 305) in the UCM thread for queued transmission.

The UCM 300A may, while ensuring data correctness, pass parameters and return values through shared memory and simulate a system call return through semaphore notification, thereby improving communication efficiency of API calls. A user may directly link the UCM 300A to an application in the form of a library.

The UCM 300A may utilize traffic steering or receive side scaling and other offloading features of the NIC 306 to ensure that, in multi-thread scenarios, related information for each connection is accessed and processed by only one thread. In this way, when creating and destroying global resources, the UCM 300A can reduce the effect scope of locking, thereby improving performance of link resource access.

For example, the UCM 300A may create a specified number of threads according to user requirements. Each thread may use a DPDK steering rule to steer corresponding data packets received by the NIC to the thread. After a UCM thread receives a connection establishment message, the UCM 300A may notify the application of the corresponding event through a pipe.

The UCM 300A may also adapt a connection establishment API based on an open-source librdmacm library. The connection establishment API may be used to provide users with standard connection management APIs, and may be used for process communication of software.

In some example embodiments, a user may, according to scenarios, use a Unix Domain Socket and/or shared memory to directly call an API to notify a thread of a connection establishment request.

In addition, based on the UCM 300A, when a user actively initiates a connection establishment or receives a connection establishment request, a data structure required for managing connection information may be created.

It should be understood that the example of the UCM 300A described in the present disclosure is merely for the purpose of description, and is not intended to impose any limitation on the embodiments of the present disclosure. The embodiments of the present disclosure may comprise any suitable number of processes or have any suitable structure, and the embodiments of the present disclosure are not limited in this regard.

FIG. 3B illustrates a schematic diagram of a signaling flow 300B for connection establishment according to some embodiments of the present disclosure. For ease of discussion and without loss of generality, the signaling flow 300B will be described with reference to FIG. 1. The signaling flow 300B comprises a first device 110 and a second device 120 in FIG. 1. As described above, the first device 110 may comprise or be implemented as a switch, a router, a virtual machine, a computing node, a storage node, and/or similar devices. In addition, the first device 110 and/or the second device 120 may comprise the UCM 300A in FIG. 3A.

The following describes, by way of example, execution of the method for connection establishment according to the present disclosure by the first device 110 and the second device 120. Specifically, the second device 120 will be described as the initiator of the connection establishment process, for example, a client, and the first device 110 will be described as the receiver of the connection establishment process, for example, a server.

First, the second device 120 determines (3010) first data for establishing an RDMA connection. The first data may comprise an identifier of the RDMA connection and an address of the second device 120, for example, an IP address. Next, based on thread configuration information for the second device 120, the second device 120 determines (3020) a thread in the second device 120 associated with the first data. The thread configuration information indicates an association between a thread and data. In some example embodiments, the thread configuration information is received from a user or is predetermined. For example, a user may indicate the number of threads in the UCM, and the UCM may set the threads based on the user’s indication.

In some example implementations, the thread configuration information for the second device 120 may be determined based on a traffic steering rule for the second device 120. The traffic steering rule is used to allocate data to at least one thread in the second device 120. For example, the traffic steering rule may comprise traffic steering or receive side scaling, such as RSS hash.

Then, the second device 120 sends (3030) a connection establishment request from the second device 120 to the first device 110 through the thread associated with the first data. The connection establishment request comprises the first data. Accordingly, the first device 110 receives (3040) the connection establishment request from the second device 120.

Next, based on thread configuration information for the first device 110, the first device 110 determines (3050) a thread in the first device 110 associated with the first data. The thread configuration information indicates an association between a thread and data. The thread associated with the first data is configured for determining whether the RDMA connection is to be established. Specifically, the first device 110 may determine whether the RDMA connection is to be established based on the first data through the thread associated with the first data. For example, the first device 110 may process the first data through the thread associated with the first data and determine, based on the first data, whether the connection establishment request received from the second device 120 meets the requirement of the first device 110.

In some example implementations, the thread configuration information for the first device 110 may be determined based on a traffic control steering rule for the first device 110. The traffic steering rule is used to allocate data to at least one thread in the first device 110. For example, the traffic steering rule may comprise traffic steering or receive side scaling, such as RSS hash.

In some example embodiments, if it is determined that the RDMA connection is not to be established, the first device 110 may send a connection rejection response to the second device 120. The connection rejection response may comprise a rejection reason, such as insufficient resources or failure to meet a requirement of the first device 110.

If it is determined that the RDMA connection is to be established, the first device 110 sends (3060) a connection establishment response to the second device 120. The connection establishment response comprises second data for establishing the RDMA connection. The second data is associated with the first data. For example, the second data may comprise an identifier of the same RDMA connection as in the first data. In some example embodiments, the second data may comprise the identifier of the RDMA connection, the address of the first device 110, and/or similar data.

Specifically, the first device 110 may determine the second data. Then, the first device 110 may determine, based on thread configuration information for the first device 110, the thread in the first device 110 associated with the second data.

The first device 110 may send the connection establishment response to the second device 120 through the thread associated with the second data.

Correspondingly, the second device 120 may receive the connection establishment response comprising the second data from the first device 110. Then, based on thread configuration information, the second device 120 may determine the thread in the second device 120 associated with the second data. The thread may be configured for determining whether the RDMA connection is to be established. Specifically, the second device 120 may determine whether the RDMA connection is to be established based on the second data through the thread associated with the second data. For example, the second device 120 may process the second data through the thread associated with the second data and determine, based on the second data, whether the connection establishment response received from the first device 110 meets the requirement of the second device 120.

In some example embodiments, if it is determined that the RDMA connection is not to be established, the second device 120 may send a connection rejection response to the first device 110. The connection rejection response may comprise a rejection reason, such as insufficient resources or failure to meet the requirement of the second device 120.

If it is determined that the RDMA connection is to be established, the second device 120 may establish the RDMA connection between the first device 110 and the second device 120 based on the second data through the thread associated with the second data. In this case, the second device 120 may send a ready message to the first device 110. Upon receiving the ready message, the first device 110 may establish the RDMA connection between the first device 110 and the second device 120 based on the first data.

In addition, the first device 110 and the second device 120 may also disconnect the RDMA connection. The disconnection process may be initiated by the first device 110 or the second device 120. The following describes the disconnection process with the first device 110 and the second device 120 as the initiator, respectively.

First, the first device 110 may determine third data for disconnecting the RDMA connection. The third data may comprise the identifier of the RDMA connection, the address of the first device 110, and/or similar data. Next, based on the thread configuration information for the first device 110, the first device 110 may determine a thread in the first device 110 associated with the third data. Then, the first device 110 may send a disconnection request from the first device 110 to the second device 120 through the thread associated with the third data. The disconnection request may comprise the third data.

Correspondingly, the second device 120 may receive the disconnection request comprising the third data from the first device 110. Then, based on the thread configuration information for the second device 120, the second device 120 may determine a thread in the second device 120 associated with the third data. The thread may be configured for disconnecting the RDMA connection between the first device 110 and the second device 120.

Then, the second device 120 may send a disconnection response to the first device 110. The disconnection response comprises fourth data for disconnecting the RDMA connection. The fourth data may be associated with the third data. For example, the fourth data may comprise the identifier of the same RDMA connection as in the third data. The fourth data may further comprise the address of the second device 120 and/or similar data.

Specifically, the second device 120 may determine the fourth data. Then, the second device 120 may determine, based on the thread configuration information for the second device 120, a thread in the second device 120 associated with the fourth data. Next, the second device 120 may send the disconnection response to the first device 110 through the thread associated with the fourth data.

Correspondingly, the first device 110 may receive the disconnection response comprising the fourth data from the second device 120. Then, based on thread configuration information for the first device 110, the first device 110 may determine a thread in the first device 110 associated with the fourth data. Based on the fourth data, the first device 110 may disconnect the RDMA connection between the first device 110 and the second device 120 through the thread associated with the fourth data. For example, the first device 110 may release, through the thread, resources associated with the fourth data and used for the RDMA connection. In this case, the first device 110 may send a ready message to the second device 120. Upon receiving the ready message, the second device 120 may disconnect the RDMA connection between the first device 110 and the second device 120 based on the third data.

In some example embodiments, the second device 120 may determine fifth data for disconnecting the RDMA connection. The fifth data may comprise the identifier of the RDMA connection, the address of the second device 120, and/or similar data. Next, based on the thread configuration information for the second device 120, the second device 120 may determine a thread in the second device 120 associated with the fifth data. Through the thread associated with the fifth data, the second device 120 may send a disconnection request to the first device 110. The disconnection request may comprise the fifth data.

Correspondingly, the first device 110 may receive the disconnection request comprising the fifth data from the second device 120. Then, based on the thread configuration information for the first device 110, the first device 110 may determine a thread in the first device 110 associated with the fifth data. The thread may be configured for disconnecting the RDMA connection between the first device 110 and the second device 120. Specifically, the first device 110 may disconnect the RDMA connection between the first device 110 and the second device 120 based on the fifth data through the thread associated with the fifth data.

Next, the first device 110 may send a disconnection response to the second device 120. The disconnection response comprises sixth data for disconnecting the RDMA connection. The sixth data may be associated with the fifth data. For example, the sixth data may comprise the identifier of the same RDMA connection as in the fifth data. The sixth data may further comprise the address of the first device 110 and/or similar data.

Correspondingly, the second device 120 may receive the disconnection response comprising the sixth data from the first device 110. Then, based on the thread configuration information for the second device 120, the second device 120 may determine a thread in the second device 120 associated with the sixth data. Based on the sixth data, the second device 120 may disconnect the RDMA connection between the first device 110 and the second device 120 through the thread associated with the sixth data. For example, the second device 120 may release, through the thread, resources associated with the sixth data and used for the RDMA connection. In this case, the second device 120 may send a ready message to the first device 110. Upon receiving the ready message, the first device 110 may disconnect the RDMA connection between the first device 110 and the second device 120 based on the fifth data.

It should be understood that the example connection establishment processes described in the present disclosure are merely for the purpose of description, and are not intended to impose any limitation on the embodiments of the present disclosure. The environment in the embodiments of the present disclosure may comprise any suitable number of devices and/or any suitable data, and the embodiments of the present disclosure are not limited in this regard.

In this way, the first device 110 and/or the second device 120 can process the data for the RDMA connection establishment or disconnection through the thread associated with the data without locking the data. Therefore, the RDMA connection between the first device 110 and the second device 120 can be flexibly and effectively established or disconnected.

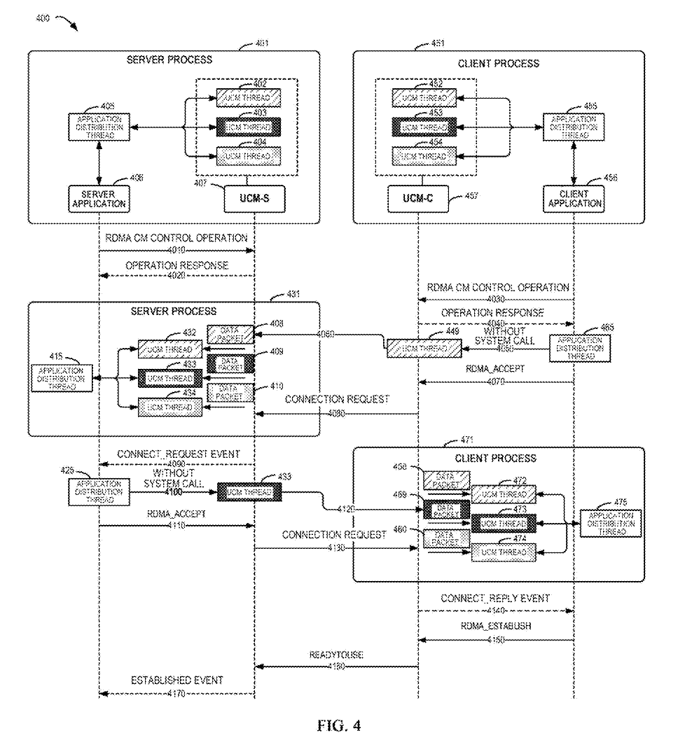

The following describes a process for connection establishment according to some embodiments of the present disclosure with reference to FIG. 4. FIG. 4 illustrates a schematic diagram 400 of a process for connection establishment according to some embodiments of the present disclosure. The example embodiment shown in FIG. 4 may be an implementation of the example embodiment discussed with reference to FIG. 3B.

As shown in FIG. 4, a server process 401 may include an application distribution thread 405, a server application 406, and a server UCM (UCM-S) 407. The application distribution thread 405 may be associated with UCM threads 402, 403, and 404. A client process 451 may include an application distribution thread 455, a client application 456, and a client UCM (UCM-C) 457. The application distribution thread 455 may be associated with UCM threads 452, 453, and 454. The UCM-S 457 and the UCM-C 407 may be implemented as the UCM 300A shown in FIG. 3A.

At 4010, the server application 406 may initiate an RDMA CM control operation to the UCM-S 407. For example, the server application 406 may use a librdmacm API (such as rdma_bind_addr or rdma_listen) to perform operations such as address binding and listening for a connection establishment request. At 4020, the UCM-S 407 may return an operation response to the server application 406. For example, the UCM-S 407 may return an application call result through the shared memory. For example, the server application 406 may create a data structure required for managing connection information.

At 4030, the client application 456 may initiate an RDMA CM control operation to the UCM-C 457. For example, the client application 456 may use a librdmacm API (such as rdma_bind_addr or rdma_resolve_route) to perform operations such as address binding and peer address route resolution. At 4040, the UCM-C 457 may return an operation response to the client application 456, for example, return an application call result through the shared memory. For example, the client application 456 may create a data structure required for managing connection information.

Next, at 4050, when a result in the operation response returned at 4040 is successfully parsed, the application distribution thread 465 may initiate a connection establishment request through a thread (for example, a UCM thread 449) in the UCM-C 457. For example, at 4070, based on the thread configuration information, because a data packet 408 used to send the connection establishment request is associated with the UCM thread 449, the client application 456 may use the rdma_connect API to call the UCM thread 449 to send the connection establishment request without using a system call. The UCM-C 457 may construct a connection establishment request message ConnectRequest (for example, a standard RDMA format or a customized protocol format may be used). At 4080, the UCM-C 457 may send the connection establishment request message ConnectRequest to the UCM-S 407.

In some example embodiments, the thread configuration information may be received from a user or predetermined. For example, the thread configuration information may be determined based on a traffic control steering rule. The traffic steering rule is used for allocating data to respective threads. For example, the traffic steering rule may include traffic steering or receive side scaling, for example, RSS hash. In some example implementations, the thread configuration information for the first device 110 and the second device 120 may be the same or different.

At 4060, the data packet 408 may be sent to the UCM-S 407 in the server process 431 through the UCM thread 449. The UCM-S 407 may determine, based on the data packet 408 and the thread configuration information, the UCM thread 432 associated with the data packet 408. In this case, the UCM-S 407 may send the data packet 408 to the thread 432 for processing. Similarly, for a data packet 409, the UCM-S 407 may determine, based on the data packet 409 and the thread configuration information, a UCM thread 433 associated with the data packet 409. In this case, the UCM-S 407 may send the data packet 409 to the thread 433 for processing. For a data packet 410, the UCM-S 407 may determine, based on the data packet 410 and the thread configuration information, a UCM thread 434 associated with the data packet 410. In this case, the UCM-S 407 may send the data packet 410 to the thread 434 for processing.

For example, the UCM-S 407 may use the application distribution thread 415 to send, based on traffic steering or receive side scaling (for example, RSS hash), a message to a thread associated with the message for processing. Because the message (or the data packet) is sent to the corresponding thread and is not accessed by another thread, the UCM-S 407 does not need to lock the message (or the data packet).

Next, after receiving the ConnectRequest message, the UCM-S 407 may verify the connection establishment request. At 4090, if the connection establishment request meets the requirement (for example, a resource indicated in the connection establishment request may be allocated to establish the RDMA connection), the UCM-S 407 may send a CONNECT_REQUEST event to the server application 406. If the connection establishment request does not meet the requirement (for example, the resource indicated in the connection establishment request cannot be allocated to establish the RDMA connection), the UCM-S 407 may send a ConnectReject message to the UCM-C 457. The ConnectReject message may include error information.

After receiving the CONNECT_REQUEST event, the server application 406 may process the event. At 4110, the server application 406 may accept the connection establishment request by using the rdma_accept API. The server application 406 may construct a connection establishment reply message ConnectReply (for example, using a standard RDMA format or a customized protocol format). At 4100, based on the thread configuration information, because the data packet (for example, a data packet 459) used to send the connection establishment response is associated with the UCM thread 433, the server application 406 may use the application distribution thread 425 to send the message to the UCM thread 433 in the UCM-S407.

At 4130, the UCM-S 407 may send a connection response to the UCM-C 457. For example, at 4120, the UCM-S 407 may send, through the UCM thread 433, the data packet (for example, the data packet 459) including the connection establishment reply message ConnectReply to the UCM-C 457. Then, the UCM-C 457 may determine, based on the data packet 459 and the thread configuration information, a UCM thread 473 associated with the data packet 459. In this case, the UCM-S 457 may send the data packet 459 to the thread 473 for processing. Similarly, for a data packet 458, the UCM-S 457 may determine, based on the data packet 458 and the thread configuration information, a UCM thread 472 associated with the data packet 458. In this case, the UCM-S 457 may send the data packet 458 to the thread 472 for processing. For a data packet 474, the UCM-S 457 may determine, based on a data packet 460 and the thread configuration information, a UCM thread 474 associated with the data packet 460. In this case, the UCM-S 457 may send the data packet 460 to the thread 474 for processing.

For example, the UCM-S 457 may use the application distribution thread 475 to send, based on traffic steering or receive side scaling (for example, RSS hash), a message to a thread associated with the message for processing. Because the message (or the data packet) is sent to the corresponding thread and is not accessed by another thread, the UCM-S 457 does not need to lock the message (or the data packet).

Next, after receiving the ConnectReply message, the UCM-S 457 may verify the connection establishment response. At 4090, if the connection establishment response meets the requirement (for example, a resource indicated in the connection establishment response may be allocated to establish the RDMA connection), at 4140, the UCM-C 457 may send a CONNECT_REPLY event to the client application 456. If the connection establishment response does not meet the requirement (for example, the resource indicated in the connection establishment response cannot be allocated to establish the RDMA connection), the UCM-C 457 may send a ConnectReject message to the UCM-S 407. The ConnectReject message may include error information.

Then, after receiving the CONNECT_REPLY event, the client application 456 may process the event. At 4150, the client application 456 may use the rdma_establish API to call the UCM-C 457 to complete the connection establishment request. The UCM-C 457 may construct a connection establishment complete message ReadyToUse (for example, a standard RDMA format or a customized protocol format may be used). At 4160, the UCM-C 457 may send the connection establishment complete message ReadyToUse to the UCM-S 407.

After receiving the connection establishment complete message ReadyToUse, at 4170, the UCM-S 407 may report an ESTABLISHED event to the server application 406 to notify the server application 406 that the connection establishment process is completed. Then, the server application 406 may start to send data.

In this way, the UCM-S 407 and the UCM-C 457 can process the data for establishing or disconnecting the RDMA connection through the thread associated with the data without locking the data. In addition, the UCM-S 407 and the UCM-C 457 can complete the connection establishment process without using a system call, without memory copy, and by task distribution based on the application distribution thread only once. Therefore, the RDMA connection between the server application 406 and the client application 456 can be flexibly and efficiently established based on the UCM-S 407 and the UCM-C 457.

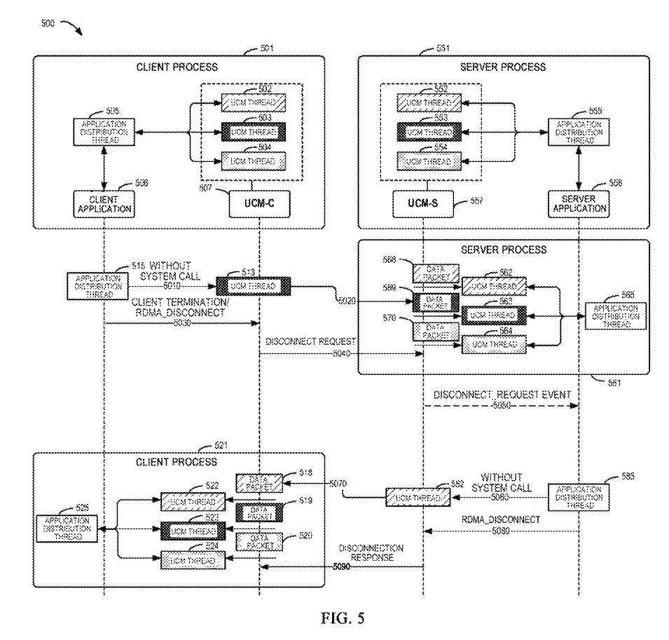

The following describes a process for disconnection according to some embodiments of the present disclosure with reference to FIG. 5. FIG. 5 illustrates a schematic diagram 500 of a process for disconnection according to some embodiments of the present disclosure. The example embodiment shown in FIG. 5 may be an implementation of the example embodiment discussed with reference to FIG. 3B.

As shown in FIG. 5, a client process 501 may comprise an application distribution thread 505, a client application 506, and a client UCM (UCM-C) 507. The application distribution thread 505 may be associated with UCM threads 502, 503, and 504. A server process 551 may comprise an application distribution thread 555, a server application 556, and a server UCM (UCM-S) 557. The application distribution thread 555 may be associated with UCM threads 552, 553, and 554. The UCM-S 557 and the UCM-C 507 may be implemented as the UCM 300A illustrated in FIG. 3A. The client process 501 may be comprised in or implemented in the second device 120, and the server process 551 may be comprised in or implemented in the first device 110. The UCM-C 507 and the UCM-S 557 may be implemented based on the UCM 300A illustrated in FIG. 3A.

The client application 506 may construct a disconnection (also referred to as disconnect) request message DisconnectRequest (for example, using a standard RDMA format or a customized protocol format). Then, at 5010, the client application 506 may invoke a UCM thread 513 through the application distribution thread 515. At 5030, the client application 506 may use an rdma_disconnect API or directly terminate, thereby triggering the disconnection request.

At 5040, the UCM-C 507 may send a disconnection request to the UCM-S 557. For example, at 5020, the UCM-C 507 may send to the UCM-S 557 a packet (for example, packet 569) comprising the disconnection request message DisconnectRequest. In the server process 561, based on thread configuration information, since the packet 569 for sending the disconnection request is associated with a UCM thread 563, the UCM-S 557 may determine, based on the packet 569 and the thread configuration information, to use the UCM thread 563 for processing the packet 569.

Similarly, for a packet 568, the UCM-S 557 may determine, based on the packet 568 and the thread configuration information, a UCM thread 562 associated with the packet 568. In this case, the UCM-S 557 may send the packet 568 to the thread 562 for processing. For a packet 570, the UCM-S 557 may determine, based on the packet 570 and the thread configuration information, a UCM thread 564 associated with the packet 570. In this case, the UCM-S 557 may send the packet 570 to the thread 564 for processing.

For example, the UCM-S 557 may use an application distribution thread 565 to send a message to a thread associated with the message for processing based on traffic steering or receive side scaling (for example, RSS hash). Since the message (or packet) is sent to the corresponding thread and is not accessed by another thread, the UCM-S 557 does not need to lock the message (or packet).

At 5050, after receiving the disconnection request message DisconnectRequest, the UCM-S 557 may report a DISCONNECT_REQUEST event to the server application 556. Upon receiving the DISCONNECT_REQUEST event, the server application 556 may process the event. For example, the server application 556 may stop sending data and release resources used for the RDMA connection.

At 5080, the server application 556 may receive the disconnection request using an rdma_disconnect API. The UCM-S 557 may construct a disconnection reply message DisconnectReply (for example, using a standard RDMA format or a customized protocol format). At 5060, based on the thread configuration information, since the packet (for example, packet 518) for sending the disconnection reply message is associated with a UCM thread 582, the server application 556 may use an application distribution thread 585 to send the message to the UCM thread 582 in the UCM-S 557.

At 5080, the UCM-S 557 may send a disconnection response to the UCM-C 507. For example, at 5070, the UCM-S 557 may send to the UCM-C 507 a packet (for example, packet 518) comprising the disconnection reply message DisconnectReply.

Then, in the client process 521, the UCM-C 507 may determine, based on the packet 518 and the thread configuration information, a UCM thread 522 associated with the packet 518. In this case, the UCM-C 507 may send the packet 518 to the thread 522 for processing. Similarly, for a packet 519, the UCM-C 507 may determine, based on the packet 519 and the thread configuration information, a UCM thread 523 associated with the packet 519. In this case, the UCM-C 507 may send the packet 519 to the thread 523 for processing. For a packet 520, the UCM-C 507 may determine, based on the packet 520 and the thread configuration information, a UCM thread 524 associated with the packet 520. In this case, the UCM-C 507 may send the packet 520 to the thread 524 for processing.

Upon receiving the disconnection reply message DisconnectReply, the UCM-C 507 may release resources used for the RDMA connection.

In this way, the UCM-S 557 and the UCM-C 507 can process the data for disconnecting the RDMA connection through the thread associated with the data without locking the data. Additionally, the UCM-S 557 and the UCM-C 507 can complete the disconnection process without using a system call, without memory copying, and by task distribution based on the application distribution thread only once. Therefore, the RDMA connection between the server application 556 and the client application 506 can be flexibly and efficiently disconnected based on the UCM-S 557 and the UCM-C 507.

In addition, the solution according to the embodiments of the present disclosure further comprises a method for operation and maintenance troubleshooting. The UCM according to the embodiments of the present disclosure (for example, the UCM 300A in FIG. 3A) may comprise a log. The log may comprise control plane call information and connection state change information. The log may be comprised in a log platform and may be viewed by logging into a physical machine.

According to the embodiments of the present disclosure, a command line tool counter for obtaining counter information from the UCM may also be comprised. The counter may record the states of all current connections and may count sending and receiving of connection establishment or disconnection messages. The counter may be viewed through a monitoring dashboard or by logging into a physical machine.

For example, in the method according to the embodiments of the present disclosure, a user may log into the monitoring dashboard to view the increases and decreases in the number of connections and the situation of message sending and receiving. If the data does not meet expectations, the user may check application call parameters. In addition, if the data meets expectations, the user may log into the log platform to view whether any connection establishment alarms or exceptions have occurred. If an alarm or exception occurs, the user may perform troubleshooting.

Additionally, the UCM according to the embodiments of the present disclosure may also be used to pre-set tracepoints. The tracepoints may comprise function call stacks and parameters. The tracepoints may be viewed through a log aggregation platform (for example, extended Berkeley Packet Filter, eBPF). The tracepoints may be viewed as needed using a bpftrace tool. The bpftrace is an advanced dynamic tracing tool based on eBPF technology, used for real-time monitoring and analysis of behaviors of kernels and applications. The tracepoints may be used to capture function call information and latency and to obtain connection establishment exceptions or bottlenecks without stopping the application.

The embodiments of the present disclosure may further comprise a command line packet capture tool tcpdump. The command line packet capture tool tcpdump may be used to obtain specific contents of connection establishment messages. The command line packet capture tool tcpdump may be viewed after packet capture based on a network packet analysis tool.

It should be understood that the example visualization operation and maintenance mechanism described in the present disclosure is merely for the purpose of description, and is not intended to impose any limitation on the embodiments of the present disclosure. The connection establishment method in the embodiments of the present disclosure may comprise any suitable operation and maintenance mechanism, and the embodiments of the present disclosure are not limited in this regard.

In this way, the connection establishment method based on the UCM according to the embodiments of the present disclosure may provide a visualization operation and maintenance mechanism. Exceptions or faults occurring in the connection establishment process can be flexibly and efficiently resolved. Therefore, the efficiency of the RDMA connection establishment process can be improved.

FIG. 6 illustrates a flowchart of a method 600 for connection establishment according to some embodiments of the present disclosure. It should be understood that the method 600 may be performed, for example, by the first device 110 or the second device 120 in FIG. 1, or other suitable devices. The following describes, by way of example, the execution of the method 600 by the first device 110.

At 610, the first device 110 receives a connection establishment request from the second device. The connection establishment request comprises first data for establishing a remote direct memory access connection. At 620, the first device 110 determines, based on thread configuration information for the first device 110, a thread in the first device 110 associated with the first data. The thread configuration information indicates an association between a thread and data. The thread associated with the first data is configured for determining whether the remote direct memory access connection is to be established. At 630, if it is determined that the remote direct memory access connection is to be established, the first device 110 sends a connection establishment response from the first device to the second device. The connection establishment response comprises second data for establishing the remote direct memory access connection. The second data is associated with the first data.

In some example embodiments, the first device 110 may determine the second data. Then, the first device 110 may determine, based on the thread configuration information, a thread in the first device 110 associated with the second data. The first device 110 may send the connection establishment response to the second device through the thread associated with the second data.

In some example embodiments, the first device 110 may determine whether the RDMA connection is to be established based on the first data through the thread associated with the first data.

In some example embodiments, if it is determined that the RDMA connection is not to be established, the first device 110 may send a connection rejection response from the first device 110 to the second device 120.

In some example embodiments, the first device 110 may establish the RDMA connection between the first device 110 and the second device based on the first data.

In some example embodiments, the first data may comprise an identifier of the RDMA connection and/or an address of the second device.

In some example embodiments, the second data may comprise an identifier of the RDMA connection and/or an address of the first device 110.

In some example embodiments, the first device 110 may determine third data for disconnecting the RDMA connection. The first device 110 may determine, based on the thread configuration information, a thread in the first device 110 associated with the third data. The first device 110 may send a disconnection request from the first device 110 to the second device through the thread associated with the third data. The disconnection request may comprise the third data.

In some example embodiments, the third data may comprise an identifier of the RDMA connection and an address of the first device 110.

In some example embodiments, the first device 110 may receive a disconnection response from the second device. The disconnection response may comprise fourth data for disconnecting the RDMA connection. The first device 110 may determine, based on the thread configuration information, a thread in the first device 110 associated with the fourth data. The first device 110 may disconnect the RDMA connection between the first device 110 and the second device based on the fourth data through the thread associated with the fourth data.

In some example embodiments, the fourth data may comprise an identifier of the RDMA connection and/or an address of the second device.

In some example embodiments, the first device 110 may receive, at the first device 110, a disconnection request from the second device. The disconnection request comprises fifth data for disconnecting the RDMA connection. The first device 110 may determine, based on the thread configuration information, a thread in the first device 110 associated with the fifth data. The thread associated with the fifth data is configured for disconnecting the RDMA connection between the first device 110 and the second device 120. The first device 110 may send a disconnection response to the second device 120. The disconnection response comprises sixth data for disconnecting the RDMA connection. The sixth data is associated with the fifth data.

In some example embodiments, the first device 110 may determine the sixth data. The first device 110 may determine, based on the thread configuration information, a thread in the first device 110 associated with the sixth data. The first device 110 may send the disconnection response to the second device through the thread associated with the sixth data.

In some example embodiments, the first device 110 may disconnect the RDMA connection between the first device 110 and the second device based on the fifth data through the thread associated with the fifth data.

In some example embodiments, the fifth data may comprise an identifier of the RDMA connection and/or an address of the second device.

In some example embodiments, the sixth data may comprise an identifier of the RDMA connection and/or an address of the first device 110.

In some example embodiments, the thread configuration information may be received from a user or may be predetermined.

In some example embodiments, the thread configuration information may be determined based on a traffic control steering rule for the first device 110. The traffic steering rule may be used to allocate data to at least one thread in the first device 110.

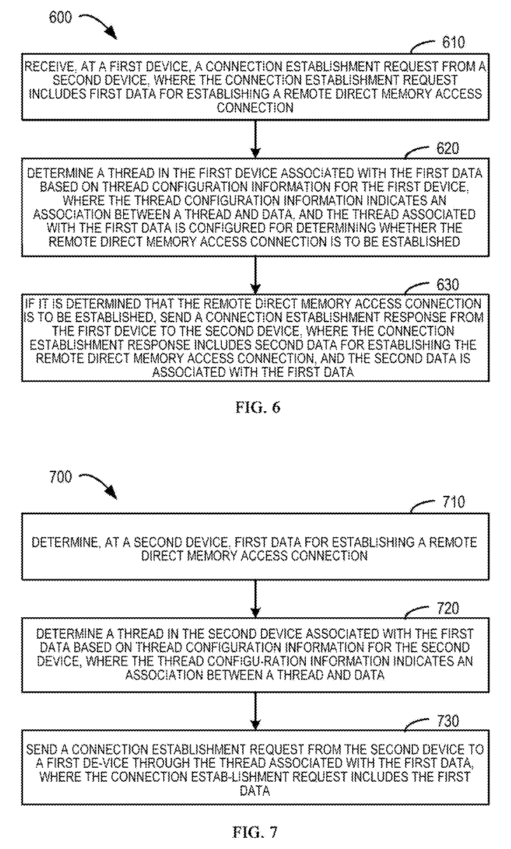

FIG. 7 illustrates a flowchart of a method 700 for connection establishment according to some embodiments of the present disclosure. It should be understood that the method 700 may be performed, for example, by the first device 110 or the second device 120 in FIG. 1, or other suitable devices. The following describes, by way of example, the execution of the method 700 by the second device 120.

At 710, the second device 120 determines first data for establishing an RDMA connection. At 720, the second device 120 determines, based on thread configuration information for the second device 120, a thread in the second device 120 associated with the first data. The thread configuration information indicates an association between a thread and data. At 730, the second device 120 sends a connection establishment request from the second device 120 to the first device through the thread associated with the first data. The connection establishment request may comprise the first data.

In some example embodiments, the second device 120 may receive, at the second device 120, a connection establishment response from the first device. The connection establishment response comprises second data for establishing the RDMA connection. The second device 120 may determine, based on the thread configuration information, a thread in the second device 120 associated with the second data. The thread associated with the second data may be configured for determining whether the RDMA connection is to be established. If it is determined that the RDMA connection is to be established, the second device 120 may establish the RDMA connection between the first device and the second device 120 based on the second data through the thread associated with the second data.

In some example embodiments, the second device 120 may determine whether the RDMA connection is to be established based on the second data through the thread associated with the second data.

In some example embodiments, if it is determined that the RDMA connection is not to be established, the second device 120 may send a connection rejection response to the first device.

In some example embodiments, the second data may comprise an identifier of the RDMA connection and/or an address of the first device.

In some example embodiments, the first data may comprise an identifier of the RDMA connection and/or an address of the second device 120.

In some example embodiments, the second device 120 may receive, at the second device 120, a disconnection request from the first device. The disconnection request may comprise third data for disconnecting the RDMA connection. The second device 120 may determine, based on the thread configuration information, a thread in the second device 120 associated with the third data. The thread associated with the third data may be configured for disconnecting the RDMA connection between the first device and the second device 120. The second device 120 may send a disconnection response from the second device 120 to the first device. The disconnection response may comprise fourth data for disconnecting the RDMA connection. The fourth data is associated with the third data.

In some example embodiments, the second device 120 may determine the fourth data. The second device 120 may determine, based on the thread configuration information, a thread in the second device 120 associated with the fourth data. The second device 120 may send the disconnection response to the first device through the thread associated with the fourth data.

In some example embodiments, the second device 120 may disconnect the RDMA connection between the first device and the second device 120 based on the third data through the thread associated with the third data.

In some example embodiments, the third data may comprise an identifier of the RDMA connection and/or an address of the first device.

In some example embodiments, the fourth data may comprise an identifier of the RDMA connection and/or an address of the second device 120.

In some example embodiments, the second device 120 may determine fifth data for disconnecting the RDMA connection. The second device 120 may determine, based on the thread configuration information, a thread in the second device 120 associated with the fifth data. The second device 120 may send a disconnection request from the second device 120 to the first device through the thread associated with the fifth data. The disconnection request may comprise the fifth data.

In some example embodiments, the fifth data may comprise an identifier of the RDMA connection and/or an address of the second device 120.

In some example embodiments, the second device 120 may receive a disconnection response from the first device. The disconnection response may comprise sixth data for disconnecting the RDMA connection. The second device 120 may determine, based on the thread configuration information, a thread in the second device 120 associated with the sixth data. The second device 120 may disconnect the RDMA connection between the first device and the second device 120 based on the sixth data through the thread associated with the sixth data.

In some example embodiments, the sixth data may comprise an identifier of the RDMA connection and an address of the first device.

In some example embodiments, the thread configuration information may be received from a user or may be predetermined.

In some example embodiments, the thread configuration information may be determined based on a traffic control steering rule for the second device 120. The traffic steering rule may be used to allocate data to at least one thread in the second device 120.

The embodiments of the present disclosure further provide corresponding apparatuses for implementing the above methods or processes. FIG. 8 illustrates a schematic structural block diagram of an apparatus 800 for connection establishment according to some embodiments of the present disclosure. The apparatus 800 may be implemented as, or comprised in, the first device 110 or the second device 120. The respective modules/components in the apparatus 800 may be implemented by hardware, software, firmware, or any combination thereof.

As shown in FIG. 8, the apparatus 800 comprises: a request reception module 810 configured to receive, at a first device, a connection establishment request from a second device, where the connection establishment request comprises first data for establishing an RDMA connection; a thread determination module 820 configured to determine, based on thread configuration information for the first device, a thread in the first device associated with the first data, where the thread configuration information indicates an association between a thread and data, and the thread associated with the first data is configured for determining whether the RDMA connection is to be established; and a response sending module 830 configured to send, in accordance with determination that the RDMA connection is to be established, a connection establishment response from the first device to the second device, where the connection establishment response comprises second data for establishing the RDMA connection, and the second data is associated with the first data.

In some example embodiments, the response sending module 830 may determine the second data. The response sending module 830 may determine, based on the thread configuration information, a thread in the first device associated with the second data. The response sending module 830 may send the connection establishment response to the second device through the thread associated with the second data.

In some example embodiments, the apparatus 800 may further comprise a connection establishment decision module configured to determine whether the RDMA connection is to be established based on the first data through the thread associated with the first data.

In some example embodiments, the apparatus 800 may further comprise a rejection response sending module configured to send, in accordance with determination that the RDMA connection is not to be established, a connection rejection response from the first device to the second device.

In some example embodiments, the apparatus 800 may further comprise a connection establishment module configured to establish the RDMA connection between the first device and the second device based on the first data.

In some example embodiments, the first data may comprise an identifier of the RDMA connection and/or an address of the second device.

In some example embodiments, the second data may comprise an identifier of the RDMA connection and/or an address of the first device.

In some example embodiments, the apparatus 800 may further comprise a disconnection module configured to determine, at the first device, third data for disconnecting the RDMA connection; determine, based on the thread configuration information, a thread in the first device associated with the third data; and send a disconnection request from the first device to the second device through the thread associated with the third data, where the disconnection request comprises the third data.

In some example embodiments, the third data may comprise an identifier of the RDMA connection and/or an address of the first device.

In some example embodiments, the apparatus 800 may further comprise a disconnection response module configured to receive, at the first device, a disconnection response from the second device, where the disconnection response comprises fourth data for disconnecting the RDMA connection; determine, based on the thread configuration information, a thread in the first device associated with the fourth data; and disconnect, based on the fourth data, the RDMA connection between the first device and the second device through the thread associated with the fourth data.

In some example embodiments, the fourth data may comprise an identifier of the RDMA connection and/or an address of the second device.

In some example embodiments, the apparatus 800 may further comprise a disconnection request reception module configured to receive, at the first device, a disconnection request from the second device, where the disconnection request comprises fifth data for disconnecting the RDMA connection; determine, based on the thread configuration information, a thread in the first device associated with the fifth data, where the thread associated with the fifth data is configured for disconnecting the RDMA connection between the first device and the second device; and send a disconnection response from the first device to the second device, where the disconnection response comprises sixth data for disconnecting the RDMA connection, and the sixth data is associated with the fifth data.

In some example embodiments, the disconnection request reception module may determine the sixth data. The disconnection request reception module may determine, based on the thread configuration information, a thread in the first device associated with the sixth data. The disconnection request reception module may send the disconnection response to the second device through the thread associated with the sixth data.

In some example embodiments, the apparatus 800 may further comprise a disconnection module configured to disconnect the RDMA connection between the first device and the second device based on the fifth data through the thread associated with the fifth data.

In some example embodiments, the fifth data may comprise an identifier of the RDMA connection and/or an address of the second device.

In some example embodiments, the sixth data may comprise an identifier of the RDMA connection and/or an address of the first device.

In some example embodiments, the thread configuration information may be received from a user or may be predetermined.

In some example embodiments, the thread configuration information may be determined based on a traffic control steering rule for the first device. The traffic steering rule may be used to allocate data to at least one thread in the first device.

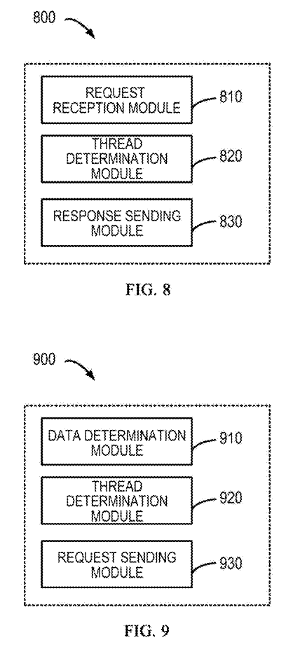

The embodiments of the present disclosure further provide corresponding apparatuses for implementing the above methods or processes. FIG. 9 illustrates a schematic structural block diagram of an apparatus 900 for connection establishment according to some embodiments of the present disclosure. The apparatus 900 may be implemented as, or comprised in, the first device 110 or the second device 120. The respective modules/components in the apparatus 900 may be implemented by hardware, software, firmware, or any combination thereof.

As shown in FIG. 9, the apparatus 900 comprises: a data determination module 910 configured to determine, at a second device, first data for establishing an RDMA connection; a thread determination module 920 configured to determine, based on thread configuration information for the second device, a thread in the second device associated with the first data, where the thread configuration information indicates an association between a thread and data; and a request sending module 930 configured to send a connection establishment request from the second device to a first device through the thread associated with the first data, where the connection establishment request comprises the first data.

In some example embodiments, the apparatus 900 may further comprise a connection establishment response reception module configured to receive, at the second device, a connection establishment response from the first device, where the connection establishment response comprises second data for establishing the RDMA connection; determine, based on the thread configuration information, a thread in the second device associated with the second data, where the thread associated with the second data is configured for determining whether the RDMA connection is to be established; and, in accordance with determination that the RDMA connection is to be established, establish the RDMA connection between the first device and the second device based on the second data through the thread associated with the second data.

In some example embodiments, the apparatus 900 may further comprise a connection establishment determination module configured to determine whether the RDMA connection is to be established based on the second data through the thread associated with the second data.

In some example embodiments, the apparatus 900 may further comprise a rejection response sending module configured to, in accordance with determination that the RDMA connection is not to be established, send a connection rejection response from the second device to the first device.

In some example embodiments, the second data may comprise an identifier of the RDMA connection and/or an address of the first device.

In some example embodiments, the first data may comprise an identifier of the RDMA connection and/or an address of the second device.

In some example embodiments, the apparatus 900 may further comprise a disconnection request reception module configured to receive, at the second device, a disconnection request from the first device, where the disconnection request comprises third data for disconnecting the RDMA connection; determine, based on the thread configuration information, a thread in the second device associated with the third data, where the thread associated with the third data is configured for disconnecting the RDMA connection between the first device and the second device; and send a disconnection response from the second device to the first device, where the disconnection response comprises fourth data for disconnecting the RDMA connection, and the fourth data is associated with the third data.

In some example embodiments, the disconnection request reception module may determine the fourth data. The disconnection request reception module may determine, based on the thread configuration information, a thread in the second device associated with the fourth data. The disconnection request reception module may send the disconnection response to the first device through the thread associated with the fourth data.

In some example embodiments, the apparatus 900 may further comprise a disconnection module configured to disconnect the RDMA connection between the first device and the second device based on the third data through the thread associated with the third data.

In some example embodiments, the third data may comprise an identifier of the RDMA connection and/or an address of the first device.

In some example embodiments, the fourth data may comprise an identifier of the RDMA connection and/or an address of the second device.

In some example embodiments, the apparatus 900 may further comprise a disconnection request sending module configured to determine, at the second device, fifth data for disconnecting the RDMA connection; determine, based on the thread configuration information, a thread in the second device associated with the fifth data; and send a disconnection request from the second device to the first device through the thread associated with the fifth data, where the disconnection request comprises the fifth data.

In some example embodiments, the fifth data may comprise an identifier of the RDMA connection and/or an address of the second device.

In some example embodiments, the apparatus 900 may further comprise a disconnection response reception module configured to receive, at the second device, a disconnection response from the first device, where the disconnection response comprises sixth data for disconnecting the RDMA connection; determine, based on the thread configuration information, a thread in the second device associated with the sixth data; and disconnect, based on the sixth data, the RDMA connection between the first device and the second device through the thread associated with the sixth data.

In some example embodiments, the sixth data may comprise an identifier of the RDMA connection and/or an address of the first device.

In some example embodiments, the thread configuration information may be received from a user or may be predetermined.

In some example embodiments, the thread configuration information may be determined based on a traffic control steering rule for the second device. The traffic steering rule may be used to allocate data to at least one thread in the second device.

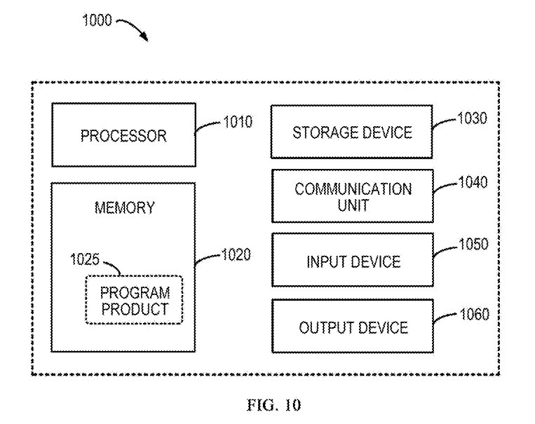

As shown in FIG. 10, an electronic device 1000 is in the form of a general-purpose electronic device. The components of the electronic device 1000 may include, but are not limited to, at least one processor 1010 or processing unit, a memory 1020, a storage device 1030, one or more communication units 1040, one or more input devices 1050, and one or more output devices 1060. The processor 1010 may be a physical or virtual processor and may execute various processing according to programs stored in the memory 1020. In a multiprocessor system, multiple processors may execute computer-executable instructions in parallel to improve the parallel processing capability of the electronic device 1000.

The electronic device 1000 typically comprises multiple computer storage media. Such media may be any media accessible to the electronic device 1000 and available for acquisition, including but not limited to volatile and non-volatile media, removable and non-removable media. The memory 1020 may be volatile memory (for example, registers, cache, random access memory (RAM)), non-volatile memory (for example, read-only memory (ROM), electrically erasable programmable read-only memory (EEPROM), flash memory), or some combination thereof. The storage device 1030 may be a removable or non-removable medium and may comprise a machine-readable medium, such as a flash drive, a disk, or any other medium that can be used to store information and/or data and can be accessed within the electronic device 1000.

The electronic device 1000 may further comprise additional removable/non-removable, volatile/non-volatile storage media. Although not shown in FIG. 10, a disk drive for reading from or writing to a removable, non-volatile magnetic disk (for example, a “floppy disk”) and an optical disk drive for reading from or writing to a removable, non-volatile optical disk may be provided. In such cases, each drive may be connected to a bus (not shown) by one or more data media interfaces. The memory 1020 may comprise a computer program product 1025 having one or more program modules configured to perform various methods or actions of the embodiments of the present disclosure.

The communication unit 1040 enables communication with other electronic devices through communication media. Additionally, the functions of the components of the electronic device 1000 may be implemented by a single computing cluster or multiple computing machines capable of communicating through communication connections. Therefore, the electronic device 1000 may operate in a networked environment using logical connections to one or more other servers, network personal computers (PCs), or other network nodes.

The input device 1050 may be one or more input devices, such as a mouse, keyboard, trackball, etc. The output device 1060 may be one or more output devices, such as a display, speakers, printer, etc. The electronic device 1000 may also communicate, as needed, via the communication unit 1040 with one or more external devices (not shown), such as storage devices, display devices, etc., with one or more devices that enable a user to interact with the electronic device 1000, or with any device that enables the electronic device 1000 to communicate with one or more other electronic devices (e.g., network card, modem, etc.). Such communication may be executed via an input/output (I/O) interface (not shown).

According to example implementations of the present disclosure, a computer-readable storage medium is provided, on which computer-executable instructions are stored, where the computer-executable instructions are executed by a processor to implement the methods described above. According to example implementations of the present disclosure, a computer program product is further provided, which is tangibly stored on a non-transitory computer-readable medium and comprises computer-executable instructions, and the computer-executable instructions are executed by a processor to implement the methods described above.

Various aspects of the present disclosure have been described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that the instructions, when executed by the processor of the computer or other programmable data processing apparatus, create means for implementing the functions/acts specified in one or more blocks of the flowcharts and/or block diagrams. The computer-readable program instructions may also be stored in a computer-readable storage medium that can direct a computer, a programmable data processing apparatus, and/or other devices to function in a particular manner, such that the computer-readable medium storing the instructions comprises an article of manufacture, which includes instructions that implement the aspects of the functions/acts specified in one or more blocks of the flowcharts and/or block diagrams.

The computer-readable program instructions may also be loaded onto a computer, other programmable data processing apparatus, or other devices to cause a series of operational steps to be performed on the computer, other programmable data processing apparatus, or other devices to produce a computer-implemented process, such that the instructions executed on the computer, other programmable data processing apparatus, or other devices implement the functions/acts specified in one or more blocks of the flowcharts and/or block diagrams.

The flowcharts and block diagrams in the drawings illustrate possible system architectures, functions, and operations of systems, methods, and computer program products according to multiple implementations of the present disclosure. In this regard, each block in the flowcharts or block diagrams may represent a module, a segment, or a portion of instructions, which comprises one or more executable instructions for implementing the specified logical functions. In some alternative implementations, the functions noted in the blocks may also occur in an order different from that illustrated in the drawings. For example, two blocks shown in succession may in fact be executed substantially concurrently, or they may sometimes be executed in the reverse order, depending on the functionality involved. It is also noted that each block of the block diagrams and/or flowcharts, and combinations of blocks in the block diagrams and/or flowcharts, may be implemented by special-purpose hardware-based systems that perform the specified functions or acts, or may be implemented by a combination of special-purpose hardware and computer instructions.

The implementations of the present disclosure have been described above. The foregoing description is for illustration and not exhaustive, and is not limited to the disclosed implementations. Many modifications and variations will be apparent to those of ordinary skill in the art without departing from the scope and gist of the implementations described. The terminology used herein is selected to best explain the principles of the implementations, the practical application, or improvements over technologies in the marketplace, or to enable others of ordinary skill in the art to understand the implementations disclosed herein.

We claim:

1. A method for connection establishment, comprising:
receiving, at a first device, a connection establishment request from a second device, wherein the connection establishment request comprises first data for establishing a remote direct memory access connection;
determining a thread in the first device associated with the first data based on thread configuration information for the first device, wherein the thread configuration information indicates an association between a thread and data, and the thread associated with the first data is configured for determining whether the remote direct memory access connection is to be established; and
in accordance with determination that the remote direct memory access connection is to be established, sending a connection establishment response from the first device to the second device, wherein the connection establishment response comprises second data for establishing the remote direct memory access connection, and the second data is associated with the first data.

2. The method of claim 1, wherein sending the connection establishment response from the first device to the second device comprises:
determining the second data;
determining a thread in the first device associated with the second data based on the thread configuration information; and
sending the connection establishment response to the second device through the thread associated with the second data.

3. The method of claim 1, further comprising:
in accordance with determination that the remote direct memory access connection is not to be established, sending a connection rejection response from the first device to the second device; and/or
in accordance with determination that the remote direct memory access connection is to be established, establishing the remote direct memory access connection between the first device and the second device based on the first data.

4. The method of claim 1, wherein the first data comprises at least one of: an identifier of the remote direct memory access connection, or an address of the second device, and/or
wherein the second data comprises at least one of: the identifier of the remote direct memory access connection, or an address of the first device.

5. The method of claim 1, further comprising:
determining, at the first device, third data for disconnecting the remote direct memory access connection;
determining a thread in the first device associated with the third data based on the thread configuration information; and
sending a disconnection request from the first device to the second device through the thread associated with the third data, the disconnection request comprising the third data.

6. The method of claim 5, wherein the third data comprises at least one of: an identifier of the remote direct memory access connection, or an address of the first device.

7. The method of claim 5, further comprising:
receiving, at the first device, a disconnection response from the second device, wherein the disconnection response comprises fourth data for disconnecting the remote direct memory access connection;
determining a thread in the first device associated with the fourth data based on the thread configuration information; and
disconnecting, based on the fourth data, the remote direct memory access connection between the first device and the second device through the thread associated with the fourth data.

8. The method of claim 1, further comprising:
receiving, at the first device, a disconnection request from the second device, wherein the disconnection request comprises fifth data for disconnecting the remote direct memory access connection;
determining a thread in the first device associated with the fifth data based on the thread configuration information, the thread associated with the fifth data being configured for disconnecting the remote direct memory access connection between the first device and the second device; and
sending a disconnection response from the first device to the second device, wherein the disconnection response comprises sixth data for disconnecting the remote direct memory access connection, and the sixth data is associated with the fifth data.

9. The method of claim 8, sending the disconnection response from the first device to the second device comprises:
determining the sixth data;
determining a thread in the first device associated with the sixth data based on the thread configuration information; and
sending the disconnection response to the second device through the thread associated with the sixth data.

10. The method of claim 8, further comprising:
disconnecting, based on the fifth data, the remote direct memory access connection between the first device and the second device through the thread associated with the fifth data.

11. The method of claim 8, wherein the fifth data comprises at least one of: an identifier of the remote direct memory access connection, or an address of the second device, and/or
wherein the sixth data comprises at least one of: the identifier of the remote direct memory access connection, or an address of the first device.

12. A method for connection establishment, comprising:
determining, at a second device, first data for establishing a remote direct memory access connection;
determining a thread in the second device associated with the first data based on thread configuration information for the second device, wherein the thread configuration information indicates an association between a thread and data; and
sending a connection establishment request from the second device to a first device through the thread associated with the first data, wherein the connection establishment request comprises the first data.

13. The method of claim 12, further comprising:
receiving, at the second device, a connection establishment response from the first device, wherein the connection establishment response comprises second data for establishing the remote direct memory access connection;
determining a thread in the second device associated with the second data based on the thread configuration information, wherein the thread associated with the second data is configured for determining whether the remote direct memory access connection is to be established; and
in accordance with determination that the remote direct memory access connection is to be established, establishing, based on the second data, the remote direct memory access connection between the first device and the second device through the thread associated with the second data.

14. The method of claim 13, further comprising:
determining, based on the second data, whether the remote direct memory access connection is to be established through the thread associated with the second data; and/or
in accordance with determination that the remote direct memory access connection is not to be established, sending a connection rejection response from the second device to the first device.

15. The method of claim 12, further comprising:
receiving, at the second device, a disconnection request from the first device, wherein the disconnection request comprises third data for disconnecting the remote direct memory access connection;
determining a thread in the second device associated with the third data based on the thread configuration information, the thread associated with the third data being configured for disconnecting the remote direct memory access connection between the first device and the second device; and
sending a disconnection response from the second device to the first device, wherein the disconnection response comprises fourth data for disconnecting the remote direct memory access connection, and the fourth data is associated with the third data.

16. The method of claim 12, further comprising:
determining, at the second device, fifth data for disconnecting the remote direct memory access connection;
determining a thread in the second device associated with the fifth data based on the thread configuration information; and
sending a disconnection request from the second device to the first device through the thread associated with the fifth data, the disconnection request comprising the fifth data.

17. An electronic device, comprising:
at least one processor; and
at least one memory coupled to the at least one processor and storing instructions executable by the at least one processor, the instructions, when executed by the at least one processor, causing the device to perform acts comprising:
receiving, at an electronic device, a connection establishment request from a second device, wherein the connection establishment request comprises first data for establishing a remote direct memory access connection;
determining a thread in the electronic device associated with the first data based on thread configuration information for the electronic device, wherein the thread configuration information indicates an association between a thread and data, and the thread associated with the first data is configured for determining whether the remote direct memory access connection is to be established; and
in accordance with determination that the remote direct memory access connection is to be established, sending a connection establishment response from the electronic device to the second device, wherein the connection establishment response comprises second data for establishing the remote direct memory access connection, and the second data is associated with the first data.

18. The electronic device of claim 17, wherein sending the connection establishment response from the electronic device to the second device comprises:
determining the second data;
determining a thread in the electronic device associated with the second data based on the thread configuration information; and
sending the connection establishment response to the second device through the thread associated with the second data.

19. The electronic device of claim 17, further comprising:
in accordance with determination that the remote direct memory access connection is not to be established, sending a connection rejection response from the electronic device to the second device; and/or
in accordance with determination that the remote direct memory access connection is to be established, establishing the remote direct memory access connection between the electronic device and the second device based on the first data.

20. The electronic device of claim 17, wherein the first data comprises at least one of: an identifier of the remote direct memory access connection, or an address of the second device, and/or
wherein the second data comprises at least one of: the identifier of the remote direct memory access connection, or an address of the electronic device.
